(19) United States
(12) Patent Application Publication
(10) Pub. No.: US 2025/0286239 A1
(43) Pub. Date: Sep. 11, 2025

(54) ELECTRODE ASSEMBLY, SECONDARY BATTERY INCLUDING THE SAME, AND METHOD OF MANUFACTURING SECONDARY BATTERY

(71) Applicant: SAMSUNG SDI CO., LTD., Yongin-Si (KR)

(72) Inventor: Kiyoun JEON, Yongin-Si (KR)

(21) Appl. No.: 18/824,382

(22) Filed: Sep. 4, 2024

(30) Foreign Application Priority Data
Mar. 8, 2024 (KR) 10-2024-0033504

(51) Int. Cl. H01M 50/533; H01M 50/536

(52) U.S. Cl. CPC H01M 50/533; H01M 50/536

(57) ABSTRACT

An electrode assembly including: an electrode plate stack including a plurality of electrode plates stacked in a first direction; and a tab stack including a plurality of electrode tabs extending from the electrode plates from among the plurality of electrode plates having the same polarity as each other in a second direction perpendicular to the first direction, and having at least one open trench extending downward through an end thereof. A lower electrode tab located at a lower side from among the plurality of electrode tabs is exposed through the open trench in an adjacent upper electrode tab located at an upper side from among the plurality of electrode tabs.

### CROSS-REFERENCES TO RELATED APPLICATION

The present application claims priority to and the benefit of Korean Patent Application No. 10-2024-0033504, filed on Mar. 8, 2024, in the Korean Intellectual Property Office, the entire disclosure of which is incorporated by reference herein.

### BACKGROUND

### 1. Field

Aspects and embodiments of the present disclosure relate to an electrode assembly, such as a stack-type electrode assembly in which a plurality of electrode plates are stacked, a secondary battery including the electrode assembly, and a method of manufacturing the secondary battery.

### 2. Description of the Related Art

Recently, as the demand for medium-sized to large-sized batteries, such as vehicle batteries, is increasing, various efforts have been made to improve the capacity of secondary batteries.

For example, in a stack-type electrode assembly formed by stacking a plurality of electrode plates onto each other, a battery capacity may be easily increased by increasing the number of stacked electrode plates, and thus, secondary batteries with a stacked electrode structure may be widely used as cells for high-capacity batteries.

A stack type electrode assembly includes a plurality of positive electrode plates and a plurality of negative electrode plates that are stacked alternately with separators therebetween. A plurality of positive electrode tabs are connected to the positive electrode plates, and stacked together with the positive electrode plates. A plurality of negative electrode tabs are connected to the negative electrode plates, and stacked together with the negative electrode plates. A single positive electrode lead joins the positive electrode tabs together, and a single negative lead joins the negative electrode tabs together.

The positive electrode lead is connected to a positive electrode terminal, and the negative electrode lead is connected to a negative electrode terminal to complete a secondary battery.

The above information disclosed in this Background section is for enhancement of understanding of the background of the present disclosure, and therefore, it may contain information that does not constitute related (or prior) art.

### SUMMARY

A plurality of stacked positive electrode tabs or a plurality of negative electrode tabs (hereinafter referred to as electrode tabs) may each be joined to a positive electrode lead together or a negative electrode lead together (hereinafter, referred to as electrode lead) through ultrasonic welding, and the single electrode lead and the electrode tabs may be electrically connected to each other concurrently (e.g., simultaneously or at the same time).

However, ultrasonic welding may be suitable in terms of a welding reliability in a case where welding base materials that are to be joined to each other are suitably thin. As such, in a case where an electrode tab is too thick, it may be difficult to stably join the electrode lead.

For example, as the demand for high-capacity secondary batteries increases, the number of stacked electrodes and the number of electrode tabs connected to the electrodes may also be increased, and thus, it may desirable for a plurality of stacked electrode tabs and an electrode lead to be stably welded together.

One or more embodiments of the present disclosure may be directed to an electrode assembly including an open trench at an end portion of an electrode tab, such that the total thickness of the stacked electrode tabs that are welded together in a stack direction may be reduced.

One or more embodiments of the present disclosure may be directed to a secondary battery including the electrode assembly.

One or more embodiments of the present disclosure may be directed to a method of manufacturing the secondary battery.

These and other aspects and features of the present disclosure will be described in or will be apparent from the following description of embodiments of the present disclosure.

According to one or more embodiments of the present disclosure, an electrode assembly includes: an electrode plate stack including a plurality of electrode plates stacked in a first direction; and a tab stack including a plurality of electrode tabs extending from the electrode plates from among the plurality of electrode plates having the same polarity as each other in a second direction perpendicular to the first direction, and having at least one open trench extending downward through an end thereof. A lower electrode tab located at a lower side from among the plurality of electrode tabs is exposed through the open trench in an adjacent upper electrode tab located at an upper side from among the plurality of electrode tabs.

In an embodiment, the tab stack may include: a plurality of bodies stacked in the first direction and extending in the second direction from the electrode plates, the bodies having a tab width in a third direction perpendicular to the first direction and the second direction; and a plurality of weld terminals integrally connected in the second direction to the bodies, and defining the open trench.

In an embodiment, each of the plurality of bodies may have a quadrangular plate shape connected to a side of a corresponding electrode plate from among the electrode plates, and may be inclined toward a center of the tab stack.

In an embodiment, the plurality of weld terminals may include a plurality of weld branches that may be spaced from each other by the at least one open trench, and having a branch width equal to a trench width of the open trench.

In an embodiment, the open trench may extend in the first direction along the plurality of weld terminals by being gradually shifted by the trench width in the third direction sequentially so that a weld terminal of the lower electrode tab located at the lower side from among the plurality of weld terminals may be exposed through the open trench located at the upper side.

In an embodiment, at least one weld terminal from among the plurality of weld terminals may include a single open trench and a pair of weld branches, and a thickness of a corresponding electrode tab from among the plurality of electrode tabs in the first direction may be reduced by ⅔.

In an embodiment, the weld terminals may include: a split weld body including the pair of weld branches integrally connected to a first peripheral portion and a second peripheral portion, respectively, of an upper body from among the bodies, and the single open trench located adjacent to a central portion of the upper body to divide the pair of weld branches; a first side weld body including a weld branch from among the plurality of weld branches that may be integrally connected to a first peripheral portion and a central portion of an intermediate body from among the bodies located below the upper body, and the open trench located adjacent to a second peripheral portion of the intermediate body; and a second side weld body including a weld branch from among the plurality of weld branches that may be integrally connected to a second peripheral portion and a central portion of a lower body from among the bodies located below the intermediate body, and the open trench located adjacent to a first peripheral portion of the lower body.

In an embodiment, a stacking unit may be repeatedly stacked along the first direction, the stacking unit including the split weld body, the first side weld body, and the second side weld body, and the weld terminals may include the second side weld body, the first side weld body, and the split weld body that may be sequentially and repeatedly stacked.

In an embodiment, the electrode plate stack may include a plurality of positive electrode plates and a plurality of negative electrode plates alternately stacked in the first direction and electrically separated from each other.

In an embodiment, each of the positive electrode plates may include any one of a lithium transition metal oxide or a lithium composite oxide applied on an aluminum plate as a positive electrode active material.

According to one or more embodiments of the present disclosure, a secondary battery includes: an electrode assembly including a plurality of electrode plates stacked in a first direction, and a plurality of electrode tabs stacked in the first direction and extending from the electrode plates; a single electrode lead connected to the electrode tabs; and a battery can accommodating the electrode assembly and the electrode lead, and including an electrode terminal connected to the electrode lead. Each of the electrode tabs has at least one open trench extending downward therethrough, and in a pair of electrode tabs that are adjacent to each other in the first direction from among the plurality of electrode tabs, a lower electrode tab located at a lower side is exposed through the open trench in an upper electrode tab located at an upper side, and a joint thickness between the electrode tabs and the electrode lead is reduced.

In an embodiment, the electrode tabs may include: a plurality of bodies stacked in the first direction and extending in a second direction perpendicular to the first direction from the electrode plates, the bodies having a tab width in a third direction perpendicular to the first direction and the second direction; and a plurality of weld terminals including a plurality of weld branches integrally connected in the second direction from the bodies, and defining the open trench.

In an embodiment, the weld terminals may include: a split weld body including a weld branch from among the plurality of weld branches that may be integrally connected to a first peripheral portion and a second peripheral portion of an upper body from among the bodies, and the open trench located adjacent to a central portion of the upper body to divide the weld branch; a first side weld body including a weld branch from among the plurality of weld branches that may be integrally connected to a first peripheral portion and a central portion of an intermediate body located below the upper body from among the bodies, and the open trench located adjacent to a second peripheral portion of the intermediate body; and a second side weld body including a weld branch from among the plurality of weld branches that may be integrally connected to a second peripheral portion and a central portion of a lower body located below the intermediate body from among the bodies, and the open trench located adjacent to a first peripheral portion of the lower body.

In an embodiment, a stacking unit may be repeatedly stacked along the first direction, the stacking unit including the split weld body, the first side weld body, and the second side weld body, and the weld terminals may include the second side weld body, the first side weld body, and the split weld body that may be sequentially and repeatedly stacked.

In an embodiment, the electrode plates may include a plurality of positive electrode plates and a plurality of negative electrode plates alternately stacked in the first direction and electrically separated from each other, and the electrode tabs may include a positive electrode tab connected to the positive electrode plates, and a negative electrode tab spaced from the positive electrode tab and connected to the negative electrode plates.

According to one or more embodiments of the present disclosure, a method of manufacturing a secondary battery, includes: forming an electrode assembly including a plurality of electrode plates stacked in a first direction, and a plurality of electrode tabs connected to the electrode plates and having at least one open trench; joining the electrode tabs and an electrode lead to each other through ultrasonic welding to form a lead assembly having a joint thickness that is reduced corresponding to the open trench; and accommodating the lead assembly in a battery can. An electrode tab located at a lower side in the first direction from among the electrode tabs is exposed through the open trench in an electrode tab located at an upper side from among the electrode tabs.

In an embodiment, the forming of the electrode assembly may include forming the open trench in an end of each of the electrode tabs, and forming a plurality of weld terminals having a plurality of weld branches defined by the open trench.

In an embodiment, the forming of the weld terminals may include: forming a split weld body including a weld branch from among the plurality of weld branches that may be located at a first peripheral portion and a second peripheral portion of an upper electrode tab from among the electrode tabs, and the open trench adjacent to a central portion of the upper electrode tab to divide the weld branch; forming a first side weld body including the open trench located adjacent to a second peripheral portion of an intermediate electrode tab located below the upper electrode tab from among the electrode tabs, and a weld branch from among the plurality of weld branches that may be located at a first peripheral portion and a central portion of the intermediate electrode tab; and forming a second side weld body including the open trench located adjacent to a first peripheral portion of a lower electrode tab located below the intermediate electrode tab from among the electrode tabs, and a weld branch from among the plurality of weld branches that may be located at a second peripheral portion and a central portion of the lower electrode tab.

In an embodiment, the weld terminals may be formed by repeatedly arranging a stacking unit including the split weld body, the first side weld body, and the second side weld body along the first direction.

In an embodiment, the forming of the lead assembly may include: loading the electrode assembly and the electrode lead on an anvil of an ultrasonic welding device, and superimposing the electrode tabs and the electrode lead on the anvil; pressing the electrode lead using a horn to press a weld portion using the anvil, the weld portion defining a superimposing area between the electrode lead and the electrode tabs; and applying ultrasonic waves onto the weld portion through the horn to weld the electrode tabs and the electrode lead to each other by frictional heat.

According to some embodiments of the present disclosure, at least one open trench may be provided to pass downward through an end of each of a plurality of electrode tabs, and in a pair of electrode tabs that are adjacent to each other along a first direction, an electrode tab that is positioned at a lower side may be exposed through an open trench provided in an electrode tab positioned at an upper side. Accordingly, a joint or joined thickness of the electrode tabs may be reduced.

According to some embodiments of the present disclosure, as the thickness of the electrode tab may be reduced, ultrasonic waves may be uniformly or substantially uniformly applied from an uppermost end to a lowermost end of weld terminals during the ultrasonic welding, and thus, the welding stability of the electrode tab and an electrode lead may be improved.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view illustrating an electrode assembly according to one or more embodiments of the present disclosure;

FIG. 2 is an enlarged cross-sectional view of a part of the electrode assembly shown in FIG. 1;

FIG. 3 is a partially enlarged exploded perspective view of an electrode tab area of the electrode assembly shown in FIG. 1;

FIG. 4 illustrates a relationship between an open trench and a weld branch according to one or more embodiments of the present disclosure;

FIG. 5 is a perspective view showing a secondary battery including the electrode assembly shown in FIG. 1 according to one or more embodiments of the present disclosure;

FIG. 6 is an exploded perspective view of the secondary battery shown in FIG. 5;

FIG. 7 is a flowchart showing a method of manufacturing the secondary battery shown in FIG. 5;

FIG. 8 is a view illustrating an ultrasonic welding device for joining an electrode tab and an electrode lead to each other through welding; and

FIG. 9 is a flowchart showing a method of welding an electrode tab and an electrode lead to each other using the ultrasonic welding device shown in FIG. 8.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components ”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

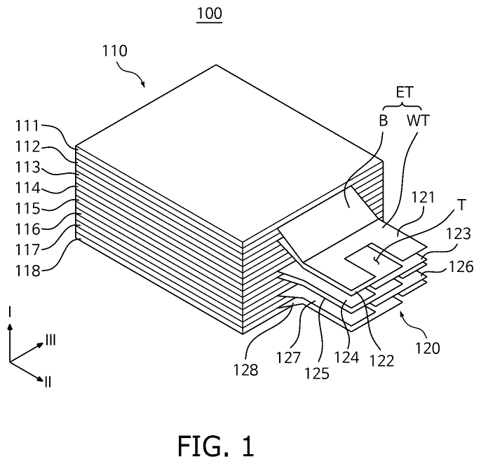

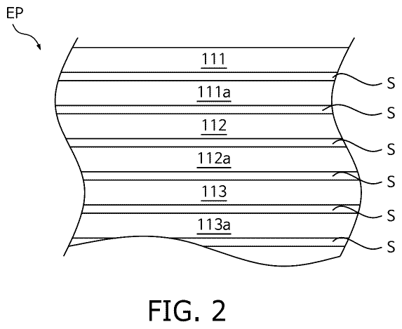

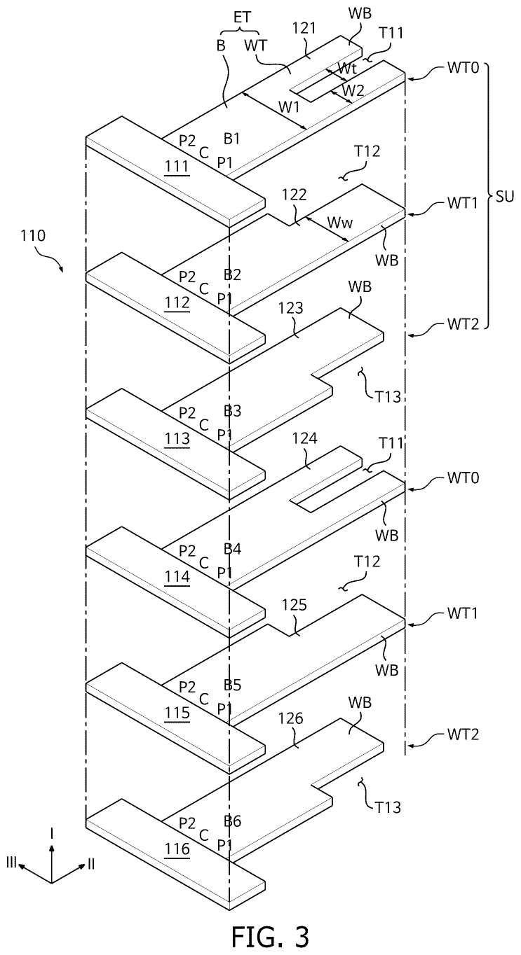

FIG. 1 is a perspective view illustrating an electrode assembly according to one or more embodiments of the present disclosure. FIG. 2 is an enlarged cross-sectional view of a part of the electrode assembly shown in FIG. 1. FIG. 3 is a partially enlarged exploded perspective view of an electrode tab area of the electrode assembly shown in FIG. 1.

Referring to FIGS. 1 and 2, an electrode assembly 100 according to one or more embodiments of the present disclosure may include an electrode plate stack portion 110 including a plurality of electrode plates EP that are stacked with separators S in between in a first direction I (e.g., a vertical direction), and a tab stack portion 120 including a plurality of electrode tabs ET extending from sides of the electrode plates EP in a second direction II (e.g., a horizontal direction) crossing the first direction I.

In some embodiments, the electrode plate EP may have a structure including an electrode slurry in which an active material, a conductive material, and a binder are mixed together and is pressed onto a flexible conductive plate using a rolling roller, and may have a polarity according to a kind of the active material.

Accordingly, in a case where an electrode slurry including a positive electrode active material is pressed onto a conductive plate, the electrode plates EP may be provided as positive electrode plates 111 to 118. In a case where an electrode slurry including a negative electrode active material is pressed onto a conductive plate, the electrode plates EP may be provided as negative electrode plates 111a to 118a.

The positive electrode plates 111 to 118 may be provided as positive electrodes for a lithium-ion battery.

For example, the positive electrode plate 111 to 118 may include a positive current collector and a positive electrode active material layer formed on the positive current collector. The positive electrode active material layer may include a positive electrode active material and may further include a binder and/or a conductive material.

In a modified example embodiment, the positive electrode plate may further include some additives for functioning the positive electrode as a sacrificial positive electrode.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Aluminum (Al) may be used as the positive current collector but is not limited thereto.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and O≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α}(0.90≤a≤1.8, 0≤b≤0.5, 0≤c≤0.5, and 0≤α≤2); LiₐNi_{1-b-c}Mn_{b}X_{c}O_{2-α}D_{α} (0.90≤a≤1.8, 0≤b≤0.5, 0≤c≤0.5, and 0≤α≤2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The negative electrode plates 111a to 118a may be provided as negative electrodes for a lithium-ion battery.

For example, the negative electrode plate 111a to 118a may include a negative current collector and a negative electrode active material layer formed on the negative current collector. The negative electrode active material layer may include a negative electrode active material and may further include a binder and/or a conductive material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon, or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

In some embodiments, the tab stack portion 120 may include the electrode tabs ET connected to extend from the sides of the electrode plates EP in the second direction II, which is the horizontal direction.

The electrode tab ET may extend in the second direction II from an uncoated portion of the electrode plate EP that is not coated with an active material layer, and may be stacked in the first direction I to correspond to a stacked structure of the electrode plate stack portion 110.

The electrode tab ET may be electrically connected to the electrode plate stack portion 110, and may provide a path for transmitting electrical signals.

Accordingly, the positive electrode plates 111 to 118 may be connected to the positive electrode tabs 121 to 128, respectively, which are the electrode tabs ET for the positive electrodes. The negative electrode plates 111a to 118a may be connected to negative electrode tabs, respectively, which are the electrode tabs ET for the negative electrodes. For example, the positive electrode tabs 121 to 128 and the negative electrode tabs may be disposed to be spaced apart from each other in the same direction (e.g., on opposite sides or side-by-side), or may be disposed in different directions from each other.

While the positive electrode tabs 121 to 128 are illustrated in the drawings and described in more detail, the negative electrode tabs may have the same or substantially the same components as those of the positive electrode tabs 121 to 128, except that the electrodes plates EP connected thereto are the negative electrode plates 111a to 118a. Accordingly, the electrode tabs ET will be described in more detail below based on the positive electrode tabs 121 to 128, and redundant description with respect to the negative electrode tabs may not be repeated.

Each electrode tab ET may include a body B and a weld terminal WT. Accordingly, the tab stack portion 120 may include a plurality of bodies B and a plurality of weld terminals WT that are stacked in the first direction I correspondently to the electrode plate stack portion 110.

The body B may have a quadrangular plate shape that extends in the second direction II from the corresponding electrode plate EP, and may have a tab width W1 in a third direction III crossing (e.g., perpendicular to or substantially perpendicular to) the first and second directions I and II. In other words, the body B may be joined to the uncoated portion of the corresponding electrode plate EP, and may extend in the quadrangular plate shape in the second direction II.

The weld terminal WT may be integrally connected from the corresponding body B in the second direction II, and may define an open trench T.

The open trench T may be provided as a space that is formed by removing a portion of the weld terminal WT, and exposes an end of the corresponding body B. Accordingly, the weld terminal WT may be connected to a portion (e.g., to only a portion) of the body B, and the end of the body B and a side of the weld terminal WT may be exposed through the open trench T.

The weld terminal WT may have a plurality of weld branches WB defined by the open trench T. The weld terminals WT may have different shapes from one another according to a combination of the open trench T and the weld branch WB.

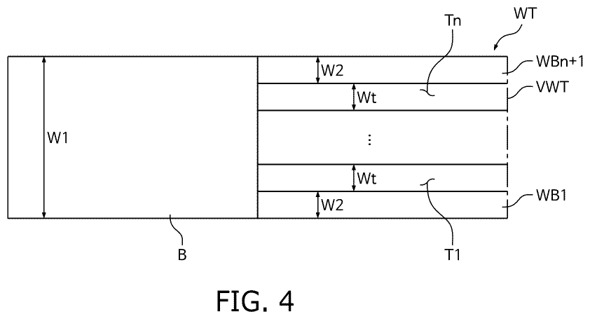

FIG. 4 illustrates a relationship between an open trench and a weld branch according to one or more embodiments of the present disclosure.

As shown in FIG. 4, the weld terminal WT may be integrally connected to the body B, and the open trench T may be formed by removing an area corresponding to a trench width Wt from a virtual weld terminal VWT having a width equal to a tab width W1.

Accordingly, in a case where n open trenches T1 to Tn are formed at a central portion of the virtual weld terminal VWT, the weld terminal WT may form n+1 weld branches WB1 to WBn+1 spaced apart (e.g., separated) from each other by the n open trenches T1 to Tn, where n is a natural number of two or more.

In other words, in a case where a plurality of open trenches T1 to Tn having the trench width Wt are disposed at the central portion of the virtual weld terminal VWT, a plurality of weld branches WB1 to WBn+1 may be disposed between opposite peripheral portions of the virtual weld terminal VWT and the open trenches T1 to Tn.

For example, in the tab stack portion 120 in which the weld terminals WT are stacked in the first direction I, the open trench T may be sequentially shifted gradually by the trench width Wt in the third direction III while extending along the weld terminal WT in the first direction I, and thus, a lower weld terminal at a lower side may be exposed through the open trench of an upper weld terminal WT positioned at an upper side.

Accordingly, the open trench T may be shifted by the trench width Wt along the tab width W1, thereby completing a shift cycle of the open trench T. In a case where the trench width Wt is equal to or substantially equal to a branch width W2, the number of weld terminals WT in the first direction I in which the open trenches T form a cycle may be determined as an integer ratio of the trench width Wt to the tab width W1.

For example, as shown in FIG. 3, in a case where the trench width Wt and the branch width W2 are equal to or substantially equal to each other, and a single open trench T is disposed in the weld terminal WT, the number of weld terminals WT in which the open trenches T that form a cycle May 3.

For example, the weld terminals WT may include a split weld body WT0, a first side weld body WT1, and a second side weld body WT2.

The split weld body WT1 may be positioned so that the weld branch WB is integrally connected to a first peripheral portion P1 and a second peripheral portion P2 of the body B, and the open trench T11 is disposed adjacent to a central portion C of the body B, such that the weld branch WB is divided.

For example, the first side weld body WT1 may be positioned so that the weld branch WB is integrally connected to the first peripheral portion P1 and the central portion C of the body B, and the open trench T12 is disposed adjacent to the second peripheral portion P2 of the body B, such that the weld branch WB is coupled to the first peripheral portion P1 of the body B.

The second side weld body WT2 may be positioned so that the weld branch WB is integrally connected to the second peripheral portion P2 and the central portion C of the body B, and the open trench T13 is disposed adjacent to the first peripheral portion P1 of the body B, such that the weld branch WB is coupled to the second peripheral portion P2 of the body B.

For example, the bodies B connected to the split weld body WT0, the first side weld body WT1, and the second side weld body WT2 may include first to third bodies B1, B2, and B3 that are sequentially connected to a first positive electrode plate 111, a second positive electrode plate 112, and a third positive electrode plate 113, respectively.

Accordingly, the second side weld body WT2, the first side weld body WT1, and the split weld body WT0 may be sequentially stacked in the first direction I, and may be provided in the weld terminals WT positioned at an upper side, an intermediate side, and a lower side, respectively.

An upper open trench T11 provided in the split weld body WT0 may be disposed adjacent to the central portion C of the first body B1, but an intermediate open trench T12 provided in the first side weld body WT1 may be shifted to the second peripheral portion P2 of the second body B2 positioned below the first body B1 and may be disposed adjacent to the second peripheral portion P2.

Accordingly, while extending from the first body B1 to the second body B2 in the first direction I, the open trench T may be shifted from the central portion C to the second peripheral portion P2.

In some embodiments, a lower open trench T13 provided in the second side weld body WT2 may be shifted to the first peripheral portion P1 of the third body B3 positioned below the second body B2 and may be disposed adjacent to the first peripheral portion P1.

Accordingly, while extending from the second body B2 to the third body B3 in the first direction I, the open trench T may be shifted from the second peripheral portion P2 of the body B2 to the first peripheral portion P1 of the body B3.

The weld terminal WT connected to a fourth body B4 positioned below the third body B3 may be shifted from the second peripheral portion P2 to both the first and second peripheral portions P1 and P2 to form the open trench T11 positioned adjacent to the central portion C. Accordingly, the weld terminal WT connected to the fourth body B4 may have the same or substantially the same configuration as that of the split weld body WT0 connected to the first body B1.

Likewise, the weld terminal WT connected to a fifth body B5 may be shifted from the first and second peripheral portions P1 and P2 to the first peripheral portion P1 to form an open trench T12 positioned adjacent to the second peripheral portion P2, and thus, may have the same or substantially the same configuration as that of the first side weld body WT1 connected to the second body B2. The weld terminal WT connected to a sixth body B6 may be shifted from the first peripheral portion P1 to the second peripheral portion P2 to form an open trench T13 positioned adjacent to the first peripheral portion P1, and thus, may have the same or substantially the same configuration as that of the second side weld body WT2 connected to the third body B3.

Therefore, the weld terminal WT may periodically form the upper open trench T11, the intermediate open trench T12, and the lower open trench T13 along the body B or the electrode plate EP, and may periodically include the split weld body WT0, the first side weld body WT1, and the second side weld body WT2.

In other words, the split weld body WT0, the first side weld body WT1, and the second side weld body WT2 may constitute a stacking unit SU of the weld terminal WT stacked in the first direction (I). The stacking unit SU of the weld terminal WT may be repeatedly disposed along the first direction I to form the tab stack portion 120 together with the body B.

According to the repeated arrangement of the stacking unit SU, the second side weld body WT2 may be partially exposed through the intermediate open trench T12 provided in the first side weld body WT1. The first side weld body WT1 may be partially exposed through the upper open trench T11 provided in the split weld body WT0. The split weld body WT0 may be partially exposed by the lower open trench T13 provided in the second side weld body WT2 of another stacking unit SU positioned at an upper side thereof.

Therefore, in a case where the weld terminal WT is welded to an electrode lead described in more detail below, an area of the open trench T may be welded to the weld terminal WT positioned at a lower side thereof without a weld base material, thereby reducing a weld thickness.

As described above, in some embodiments, the open trench T may be disposed such that the weld terminal WT has a trench width corresponding to ⅓ of the tab width W1, and thus, a thickness of the weld terminal WT stacked in the first direction I may be reduced to ⅔ of the tab width.

Accordingly, even in a case where the number of stacks of the weld terminals WT is increased (e.g., is relatively large), the electrode lead and the weld terminal WT may be stably welded to each other.

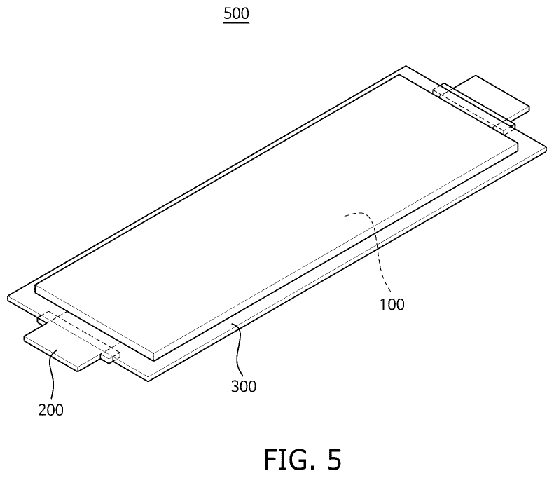

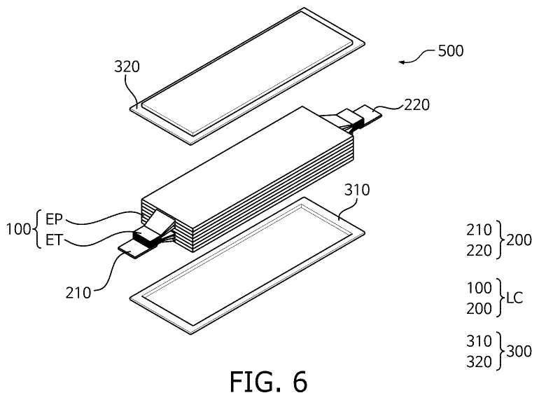

FIG. 5 is a perspective view illustrating a secondary battery including the electrode assembly shown in FIG. 1 according to one or more embodiments of the present disclosure. FIG. 6 is an exploded perspective view of the secondary battery shown in FIG. 5.

Referring to FIGS. 5 and 6, a secondary battery 500 according to an embodiment of the present disclosure may include an electrode assembly 100, an electrode lead 200, and a battery can 300.

For example, the electrode assembly 100 may include a plurality of electrode plates EP stacked in the first direction I, and a plurality of electrode tabs ET, which are each connected to one of the electrode plates EP to extend in the second direction II and are stacked in the first direction I of the electrode plates EP.

The electrode assembly 100 may have the same or substantially the same configuration as that of the electrode assembly 100 described above with reference to FIGS. 1 to 4.

In other words, the electrode plates EP may include the plurality of positive electrode plates 111 to 118 and the plurality of negative electrode plates 111a to 118a that separated from one another by separators S, and alternately stacked in the first direction I.

The positive electrode plates 111 to 118 for the secondary battery 500 may be manufactured for a lithium ion battery by applying any one of a lithium transition metal oxide or a lithium composite oxide on an aluminum plate as a positive electrode active material.

The electrode tabs ET may extend in the second direction II from the electrode plates EP, and may have the tab width W1 in the third direction perpendicular to or substantially perpendicular to the first and second directions I and II, and are stacked on one another. The electrode tabs may include a plurality of weld terminals WT, which are integrally connected from the bodies B in the second direction II, and weld branches WB defined by open trenches T.

At least one open trench T may be provided to pass downward through an end of each of the electrode tabs ET. In a pair of electrode tabs ET that are adjacent to each other in the first direction I, a lower tab as the electrode tab ET position at a lower side may be exposed through the open trench T provided in an upper tab as the electrode tab ET positioned at an upper side.

Accordingly, a joint thickness between the electrode tabs ET and the electrode lead 200 may be reduced.

In a case where a single open trench T is disposed in each of the weld terminals WT, the weld terminals WT may include a split weld body WT0 having the open trench T disposed adjacent to a central portion C of the body B, and the weld branches WB that are spaced apart (e.g., separated) from each other. The weld terminals WT may further include a first side weld body WT1 disposed so that the open trench T is disposed adjacent to a second peripheral portion of the body so that the weld branch WB is coupled to a first peripheral portion P1 of the body B, and a second side weld body WT2 disposed so that the open trench T is disposed adjacent to the first peripheral portion P1 of the body B so that the weld branch WB is coupled to the second peripheral portion P2 of the body B.

The split weld body WT0, the first side weld body WT1, and the second side weld body WT2 may constitute a stacking unit SU of the weld terminal WT, and the stacking unit SU may be repeatedly positioned (e.g., stacked) along the first direction I.

Accordingly, a thickness of the weld terminal WT corresponding to the open trench T may be removed or reduced, thereby reducing a joint thickness of the weld terminal WT in the first direction I. In some embodiments, the weld branch WB and the open trench T may have the same or substantially the same width as each other, and a trench width Wt may correspond to ⅓ of the tab width W1, so that the joint thickness may be reduced to ⅔ as compared with a weld terminal of a comparative example in which the open trench T is not disposed.

The electrode lead 200 may be joined to the weld terminal WT through ultrasonic welding to electrically connect the electrode assembly 100 to the outside.

For example, the electrode lead 200 may include (e.g., may be made of) the same material as that of the electrode plate EP for uniformity and stability of the welding. For example, the positive electrode weld terminals WT connected to the positive electrode plates 111 to 118 may include (e.g., may be made of) aluminum, and the negative electrode weld terminals WT connected to the negative electrode plates 111a to 118a may include (e.g., may be made of) copper.

The electrode lead 200 may be superimposed on an upper portion or a lower portion of the weld terminal WT to form a weld portion, and ultrasonic waves may be applied to join the weld terminal WT and the electrode lead 200 to each other by frictional heat.

For example, the joint thickness of the weld terminal WT may be reduced in the first direction I, and thus, the intensity of the ultrasonic waves may be maintained uniformly or substantially uniformly from the weld terminal WT at an uppermost side to the weld terminal WT at a lowermost side. Accordingly, the weld terminal WT and the electrode lead 200 may be stably joined with each other through ultrasonic welding.

For example, the electrode lead 200 joined to the positive electrode plates 111 to 118 may be provided as a positive electrode lead 210, and the electrode lead 200 joined to the negative electrode plates 111a to 118a may be provided as a negative electrode lead 220. Accordingly, the electrode lead 200 may be joined to the electrode assembly 100 to provide a lead assembly LC.

The battery can 300 may include a bottom plate 310 and a cover plate 320, and may have an accommodation space therebetween for accommodating the lead assembly LC.

The lead assembly LC may be disposed on the bottom plate 310, the cover plate 320 may cover and accommodate the lead assembly LC, and the bottom plate 310 and the cover plate 320 may be joined to each other through welding to seal the lead assembly LC.

For example, the electrode lead 200 may protrude to the outside of the battery can 300, and may function as an electrode terminal that electrically connects the electrode assembly 100 to the outside.

According to the secondary battery as described above, the open trench T may be disposed at an end of the weld terminal WT, and the weld terminal WT positioned at a lower side may be exposed through the open trench T of the weld terminal WT positioned at an upper side, thereby reducing the joint thickness of the weld terminal WT.

Accordingly, the intensity of the ultrasonic waves may be maintained uniformly or substantially uniformly from the weld terminal WT at an uppermost side to the weld terminal WT at a lowermost side during ultrasonic welding, thereby improving the welding stability of the electrode tab ET and the electrode lead 200.

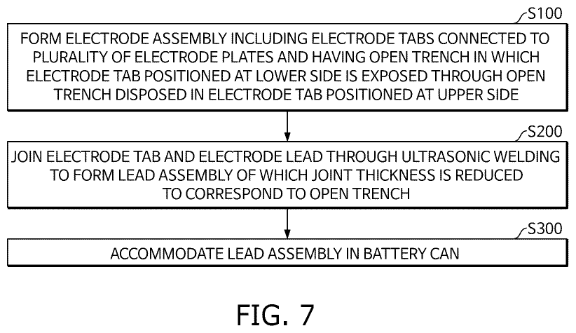

FIG. 7 is a flowchart showing a method of manufacturing the secondary battery shown in FIG. 5.

Referring to FIG. 7, first, an electrode assembly 100 including electrode tabs connected to a plurality of electrode plates and having an open trench T in which an electrode tab positioned at a lower side is exposed through an open trench disposed in an electrode tab positioned at an upper side is formed (S100). In other words, the electrode assembly 100 in which the electrode tabs having the open tranches T are stacked is formed.

Positive electrode plates 111 to 118 and negative electrode plates 111a to 118a may be alternately stacked and separated from each other by separators S therebetween. Then, electrode tabs ET, which are joined to uncoated portions of the positive electrode plates 111 to 118 and the negative electrode plates 111a to 118a and in which the open trenches T are formed at ends thereof, may be formed.

A bulk tab in which the open trench T is not formed may be joined to the uncoated portion, and then an end thereof may be cut to have a trench width Wt, thereby forming the open trench T. In other embodiments, the open trench T may be formed in the electrode tab ET in advance, and then the electrode tab ET having the open trench T may be individually joined to the uncoated portion for each electrode plate EP.

For example, a plurality of electrode tabs ET may be formed, such that a lower electrode tab positioned at a lower side in the first direction I is exposed through the open trench T disposed in an upper electrode tab positioned at an upper side.

For example, a single open trench T may be formed in an end of each of the electrode tabs ET, thereby forming a plurality of weld terminals WT having a plurality of weld branches WB defined by the open trench T.

For example, the weld terminals WT may be completed by sequentially forming a split weld body WT0, a first side weld body WT1, and a second side weld body WT2.

In the split weld body WT0, the open trench T may be formed adjacent to a central portion C of an upper electrode tab 121, which is one of the electrode tabs ET, and the weld branch WB may be disposed at a first peripheral portion P1 and a second peripheral portion P2 of the upper electrode tab 121, which define the central portion C, so that the weld branches WB may be formed to be divided.

In the first side weld body WT1, the open trench T may be formed adjacent to the second peripheral portion P2 of an intermediate electrode tab 122 positioned below the upper electrode tab, and the weld branch WB may be disposed at the first peripheral portion P1 and the central portion C of the intermediate electrode tab 122, so that the weld branch WB may be formed to be disposed at the first peripheral portion P1 of the intermediate electrode tab 122.

In the second side weld body WT2, the open trench T may be formed adjacent to the first peripheral portion P1 of a lower electrode tab 123 positioned below the intermediate electrode tab 122, and the weld branch WB may be disposed at the second peripheral portion P2 and the central portion C of the lower electrode tab 123, so that the weld branch WB may be positioned at the second peripheral portion P2 of the lower electrode tab 123.

For example, the weld terminals WT may be formed by repeatedly arranging a stacking unit SU, which includes the split weld body WT0, the first side weld body WT1, and the second side weld body WT2, along the first direction I.

Accordingly, the second side weld body WT2 may be exposed through the open trench T provided in the first side weld body WT1, the first side weld body WT1 may be exposed through the open trench T provided in the split weld body WT0, and the split weld body WT0 may be exposed through the open trench T provided in the second side weld body WT2 of an adjacent stacking unit.

As such, the electrode tab ET may be removed from each weld terminal WT by the trench width Wt, thereby reducing a joint thickness in the first direction I.

Next, the electrode tab ET and an electrode lead 200 may be joined to each other through ultrasonic welding to form a lead assembly LC of which a joint thickness is reduced to correspond to the open trench T (S200).

The electrode tab ET and the electrode lead 200 may be joined to each other using an ultrasonic welding device.

The lead assembly is accommodated in a battery can (S300), and a secondary battery 500 may be formed.

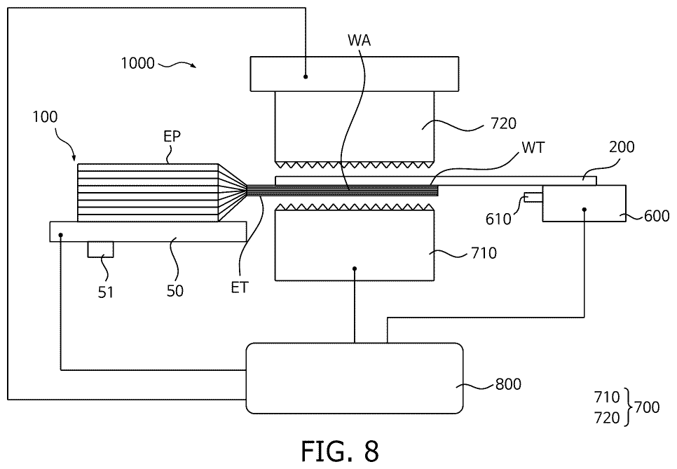

FIG. 8 is a view illustrating an ultrasonic welding device for joining an electrode tab and an electrode lead to each other through welding.

Referring to FIG. 8, an ultrasonic welding device 1000 according to one or more embodiments of the present disclosure may include an electrode mount 50 on which an electrode assembly 100 including a plurality of stacked electrode plates EP is positioned, a lead mount 600 on which an electrode lead 200 is positioned, a welding module (e.g., a welder or a welding device) 700 including an anvil 710 and a horn 720, and a driving controller 800.

For example, the electrode assembly 100 including the stacked electrode plates EP and electrode tabs ET individually extending from the electrode plates EP may be fixed to the electrode mount 50. The electrode tab ET may include a plurality of weld terminals WT in which a split weld body WT0, a first side weld body WT1, and a second side weld body WT2 are repeatedly stacked along the first direction I.

The electrode mount 50 may include a driving means (e.g., a driver) that moves in vertical and horizontal directions, and a position detector 51 for detecting a position of a weld terminal WT above the anvil 710, and thus, the electrode mount 50 may move in the vertical and horizontal directions, thereby arranging the weld terminal WT at a desired position (e.g., a set or predetermined position) on the anvil 710.

In other words, the electrode assembly 100 may be fixed to the electrode mount 50, and the position of the electrode mount 50 may be adjusted so that the weld terminal WT is positioned at the desired position on the anvil 710.

An electrode lead 200 that is joined to the weld terminal WT may be disposed on the lead mount 600. The electrode lead 200 may be manufactured separately from the electrode assembly 100, and fixed to the lead mount 600.

For example, the lead mount 600 may include a driving means (e.g., a driver) that moves in the vertical and horizontal directions, and a lead position detector 610 for detecting a position of the electrode lead 200 above the anvil 710, and thus, the lead mount 600 may move in the vertical and horizontal directions, thereby arranging the electrode lead 200 at a desired position (e.g., a set or predetermined position) on the anvil 710.

A weld portion WA may be formed by adjusting the electrode mount 50 and the lead mount 600, such that the weld terminal WT and the electrode lead 200 are superimposed on each other in a desired weld area (e.g., a set or predetermined weld area).

The welding module 700 may include the anvil 710, on which the weld terminal WT and the electrode lead 200 are disposed to be superimposed on each other, and the horn 720 positioned above the anvil 710.

The anvil 710 may be provided as a bulk welding die capable of supporting the weld terminal WT during a welding process. For example, the anvil 710 may be provided as a three-dimensional structure having a lower concave-convex portion capable of fixing the weld terminal WT on an upper surface, and may have enough strength to support a pressing force of the horn 720 during a welding process.

The horn 720 may be provided as a pressing structure that may be disposed above the anvil 710 to press the anvil 710. A concave-convex portion capable of fixing the electrode lead 200 extending to the weld area WA may be provided on a rear surface of the horn 720 to fix the electrode lead 200 during welding.

At least one of the anvil 710 or the horn 720 may move toward each other to press the weld terminal WT and the electrode lead 200 positioned in the weld area WA together. Accordingly, in a state in which the weld portion WA, in which the weld terminal WT and the electrode lead 200 are positioned to be superimposed on each other, is pressed, an ultrasonic generator provided in the horn 720 may be driven to weld the weld portion WA.

Accordingly, the weld terminal WT and the electrode lead 200 disposed between the anvil 710 and the horn 720 may be welded to each other by the welding module 700 by (e.g., according to) a size of the weld portion WA.

The driving controller 800 may drive the electrode mount 50, the lead mount 600, the anvil 710, and the horn 720 to align the weld terminal WT and the electrode lead 200 in the weld area WA on the anvil 710, and press the anvil 710 and the horn 720 together at a desired pressure (e.g., a set or predetermined pressure).

After the electrode mount 50 and the lead mount 600 are each controlled to form the weld portion WA in which the weld terminal WT and the electrode lead 200 are superimposed on each other in the weld area WA on the anvil 710, the anvil 710 and the horn 720 may be driven to approach each other, thereby pressing the weld terminal WT and the electrode lead 200 of the weld portion WA against each other.

In a state in which the weld terminal WT and the electrode lead 200 are pressed against each other on the anvil 710, the weld terminal WT and the electrode lead 200 of the weld portion WA may be welded to each other by applying ultrasonic waves to the weld area WA.

The driving controller 800 may further include a thickness detector to adjust the pressure between the anvil 710 and the horn 720 according to a desired thickness of the weld terminal WT. In other words, the driving controller 800 may adjust a moving distance of the anvil 710 and the horn 720 according to a desired thickness of the electrode tab ET.

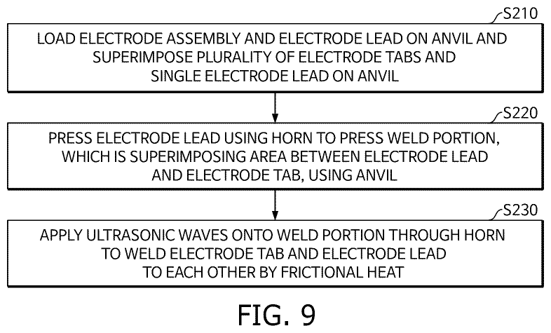

FIG. 9 is a flowchart showing a method of welding an electrode tab and an electrode lead to each other using the ultrasonic welding device shown in FIG. 8.

Referring to FIG. 9, first, an electrode assembly 100 and an electrode lead 200 may be loaded on the anvil 710 of the ultrasonic welding device 1000, and a plurality of electrode tabs ET and a single electrode lead 200 may be superimposed (e.g., may be loaded) on the anvil 710 (S210).

In a case where an electrode assembly 100 in which the electrode tabs ET are stacked is formed, the electrode assembly 100 may be loaded on the electrode mount 50 of the ultrasonic welding device 1000 to position a weld terminal WT of the electrode tab ET on an adjacent anvil 710. For example, the electrode assembly 100 may be aligned, such that the weld terminal WT is positioned at a desired position (e.g., a set or predetermined position) of the anvil 710 using the tab position detector 51 and the driver (e.g., the driving means).

The weld terminal WT and the electrode lead 200 to be welded to each other may be loaded on the lead mount 600, and supplied to an upper part of the adjacent anvil 710. For example, the electrode lead 200 may be aligned, such that the electrode lead 200 is positioned at a desired position (e.g., a set or predetermined position) on the anvil 710 using the lead position detector 610 and the driver (e.g., the driving means).

A weld portion WA may be formed by controlling the electrode mount 50 and the lead mount 600, such that the weld terminal WT and the electrode lead 200 are superimposed on each other in the weld area.

In some embodiments, although the electrode lead 200 is described as being disposed on the weld terminal WT, an arrangement thereof may be variously modified as needed or desired according to the desired device characteristics of the welding device.

Next, the electrode lead 200 may be pressed with the horn 720 to press the weld portion WA, which is a superimposing area between the electrode lead 200 and the electrode tab ET, with the anvil 710 (S220).

In a case where the weld portion WA is formed in the desired area on the anvil 710, the horn 720 may be lowered to press the weld portion WA toward the anvil 710 at a constant or substantially constant pressure. Accordingly, the weld portion WA may be pressed between the anvil 710 and the horn 720. The anvil 710 and the horn 720 may operate together to function as the welding module 700 that applies a pressing force and transversal vibrations.

A pressure applied on the weld portion WA may be determined in consideration of a thickness of the electrode lead 200 and a thickness of the weld terminal WT. For example, the thickness of the weld terminal WT may be reduced due to an open trench T, and thus, a sufficient pressing effect may be achieved even with a relatively lower pressure.

In a case where the weld portion WA is pressed at the same pressure as a pressure applied to the weld terminal WT in which the open trench T is not disposed, an effect of pressing the weld portion WA may be further increased.

Next, ultrasonic waves may be applied onto the weld portion WA through the horn 720 to weld the electrode tab ET and the electrode lead 200 to each other by frictional heat (S230).

In a case where ultrasonic waves are generated through an ultrasonic oscillator provided in the horn 720 in a state in which the weld portion WA is pressed against the anvil 710, the weld terminal WT and the electrode lead 200 may be welded to each other by intermolecular friction heat in the pressed weld portion WA.

In a case where ultrasonic waves are applied to the weld portion WA to which a pressing force is applied in a vertical direction, transversal vibrations in a pressurized state may be generated to generate an intermolecular frictional force between the weld terminal WT and the electrode lead 200 that are in contact with each other, and thus, the weld terminal WT and the electrode lead 200 may be fused together. Ultrasonic waves may have a relatively high frequency in a range of about 20 KHz to about 30 KHz.

The electrode mount 50, the lead mount 600, and the welding module 700 may be organically controlled by the driving controller 800 to apply a pressing force corresponding to the thickness of the weld terminal WT and the thickness of the electrode lead 200, and a desired frequency range (e.g., a set or predetermined frequency range) of the ultrasonic waves corresponding to the characteristics of the weld terminal WT and the electrode lead 200.

Accordingly, a lead assembly LC in which the electrode lead 200 and the electrode tab ET are joined to each other may be formed.

After the completed lead assembly LC is aligned on a bottom plate 310, a cover plate 320 may be fixed to the bottom plate 310, thereby accommodating the lead assembly LC in an accommodation of the cover plate 320.

For example, laser welding may be performed along a peripheral portion of the bottom plate 310 and the cover plate 320 to seal the accommodation space from the outside, and an electrolyte may be injected into the accommodation space in which the lead assembly LC is accommodated, thereby completing a secondary battery.

For example, the electrode lead 200 may protrude to the outside of a battery can 300, and may function as an electrode terminal that may electrically connect the electrode assembly 100 to an external load or a power source.

In other embodiments, the electrode lead 200 exposed to the outside may be formed as a positive electrode lead 210 connected to a positive electrode plate of the electrode assembly, and a negative electrode lead 220 connected to a negative electrode plate. The positive electrode lead 210 and the negative electrode lead 220 may be disposed at the same side as each other or at different sides from each other of the battery can 300.

According to an electrode assembly, a secondary battery including the same, and a method of manufacturing the secondary battery according to one or more embodiments described above, at least one open trench may be provided to pass downward through an end of each of a plurality of electrode tabs, and in a pair of electrode tabs that are adjacent to each other along a first direction, an electrode tab positioned at a lower side may be exposed through an open trench provided in an electrode tab positioned at an upper side. Accordingly, a joint thickness of the electrode tabs may be reduced.

According to one or more embodiments of the present disclosure, the thickness of the electrode tab may be reduced, and thus, ultrasonic waves may be uniformly or substantially uniformly applied from an uppermost end to a lowermost end of the weld terminals during ultrasonic welding, and thus, the welding stability of the electrode tab and an electrode lead may be improved.

The electronic or electric devices and/or any other relevant devices or components according to embodiments of the present disclosure described herein (e.g., the driving controller) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

1 what is claimed is:

1. An electrode assembly comprising:
an electrode plate stack comprising a plurality of electrode plates stacked in a first direction; and
a tab stack comprising a plurality of electrode tabs extending from the electrode plates from among the plurality of electrode plates having the same polarity as each other in a second direction perpendicular to the first direction, and having at least one open trench extending downward through an end thereof,
wherein a lower electrode tab located at a lower side from among the plurality of electrode tabs is exposed through the open trench in an adjacent upper electrode tab located at an upper side from among the plurality of electrode tabs.

2. The electrode assembly as claimed in claim 1, wherein the tab stack comprises:
a plurality of bodies stacked in the first direction and extending in the second direction from the electrode plates, the bodies having a tab width in a third direction perpendicular to the first direction and the second direction; and
a plurality of weld terminals integrally connected in the second direction to the bodies, and defining the open trench.

3. The electrode assembly as claimed in claim 2, wherein each of the plurality of bodies has a quadrangular plate shape coupled to a side of a corresponding electrode plate from among the electrode plates, and is inclined toward a center of the tab stack.

4. The electrode assembly as claimed in claim 2, wherein the plurality of weld terminals comprises a plurality of weld branches that are spaced from each other by the at least one open trench, and having a branch width equal to a trench width of the open trench.

5. The electrode assembly as claimed in claim 4, wherein the open trench extends in the first direction along the plurality of weld terminals by being gradually shifted by the trench width in the third direction sequentially so that a weld terminal of the lower electrode tab located at the lower side from among the plurality of weld terminals is exposed through the open trench located at the upper side.

6. The electrode assembly as claimed in claim 5, wherein at least one weld terminal from among the plurality of weld terminals comprises a single open trench, and a pair of weld branches, and
wherein a thickness of a corresponding electrode tab from among the plurality of electrode tabs in the first direction is reduced by ⅔.

7. The electrode assembly as claimed in claim 6, wherein the weld terminals comprise:
a split weld body comprising the pair of weld branches integrally connected to a first peripheral portion and a second peripheral portion, respectively, of an upper body from among the bodies, and the single open trench located adjacent to a central portion of the upper body to divide the pair of weld branches;
a first side weld body comprising a weld branch from among the plurality of weld branches that is integrally connected to a first peripheral portion and a central portion of an intermediate body from among the bodies located below the upper body, and the open trench located adjacent to a second peripheral portion of the intermediate body; and
a second side weld body comprising a weld branch from among the plurality of weld branches that is integrally connected to a second peripheral portion and a central portion of a lower body from among the bodies located below the intermediate body, and the open trench located adjacent to a first peripheral portion of the lower body.

8. The electrode assembly as claimed in claim 7, wherein a stacking unit is repeatedly stacked along the first direction, the stacking unit comprising the split weld body, the first side weld body, and the second side weld body, and
wherein the weld terminals comprise the second side weld body, the first side weld body, and the split weld body that are sequentially and repeatedly stacked.

9. The electrode assembly as claimed in claim 1, wherein the electrode plate stack comprises a plurality of positive electrode plates and a plurality of negative electrode plates alternately stacked in the first direction and electrically separated from each other.

10. The electrode assembly as claimed in claim 9, wherein each of the positive electrode plates comprises any one of a lithium transition metal oxide or a lithium composite oxide applied on an aluminum plate as a positive electrode active material.

11. A secondary battery comprising:
an electrode assembly comprising a plurality of electrode plates stacked in a first direction, and a plurality of electrode tabs stacked in the first direction and extending from the electrode plates;
a single electrode lead connected to the electrode tabs; and
a battery can accommodating the electrode assembly and the electrode lead, and comprising an electrode terminal connected to the electrode lead,
wherein each of the electrode tabs has at least one open trench extending downward therethrough, and
wherein, in a pair of electrode tabs that are adjacent to each other in the first direction from among the plurality of electrode tabs, a lower electrode tab located at a lower side is exposed through the open trench in an upper electrode tab located at an upper side, and a joint thickness between the electrode tabs and the electrode lead is reduced.

12. The secondary battery as claimed in claim 11, wherein the electrode tabs comprise:
a plurality of bodies stacked in the first direction and extending in a second direction perpendicular to the first direction from the electrode plates, the bodies having a tab width in a third direction perpendicular to the first direction and the second direction; and
a plurality of weld terminals comprising a plurality of weld branches integrally connected in the second direction from the bodies, and defining the open trench.

13. The secondary battery as claimed in claim 12, wherein the weld terminals comprise:
a split weld body comprising a weld branch from among the plurality of weld branches that is integrally connected to a first peripheral portion and a second peripheral portion of an upper body from among the bodies, and the open trench located adjacent to a central portion of the upper body to divide the weld branch;
a first side weld body comprising a weld branch from among the plurality of weld branches that is integrally connected to a first peripheral portion and a central portion of an intermediate body located below the upper body from among the bodies, and the open trench located adjacent to a second peripheral portion of the intermediate body; and
a second side weld body comprising a weld branch from among the plurality of weld branches that is integrally connected to a second peripheral portion and a central portion of a lower body located below the intermediate body from among the bodies, and the open trench located adjacent to a first peripheral portion of the lower body.

14. The secondary battery as claimed in claim 13, wherein a stacking unit is repeatedly stacked along the first direction, the stacking unit comprising the split weld body, the first side weld body, and the second side weld body, and
the weld terminals comprise the second side weld body, the first side weld body, and the split weld body that are sequentially and repeatedly stacked.

15. The secondary battery as claimed in claim 11, wherein the electrode plates comprise a plurality of positive electrode plates and a plurality of negative electrode plates alternately stacked in the first direction and electrically separated from each other, and
wherein the electrode tabs comprise a positive electrode tab connected to the positive electrode plates, and a negative electrode tab spaced from the positive electrode tab and connected to the negative electrode plates.

16. A method of manufacturing a secondary battery, the method comprising:
forming an electrode assembly comprising a plurality of electrode plates stacked in a first direction, and a plurality of electrode tabs connected to the electrode plates and having at least one open trench;
joining the electrode tabs and an electrode lead to each other through ultrasonic welding to form a lead assembly having a joint thickness that is reduced corresponding to the open trench; and
accommodating the lead assembly in a battery can,
wherein an electrode tab located at a lower side in the first direction from among the electrode tabs is exposed through the open trench in an electrode tab located at an upper side from among the electrode tabs.

17. The method claimed in claim 16, wherein the forming of the electrode assembly comprises forming the open trench in an end of each of the electrode tabs, and forming a plurality of weld terminals having a plurality of weld branches defined by the open trench.

18. The method claimed in claim 17, wherein the forming of the weld terminals comprises:
forming a split weld body comprising a weld branch from among the plurality of weld branches that is located at a first peripheral portion and a second peripheral portion of an upper electrode tab from among the electrode tabs, and the open trench adjacent to a central portion of the upper electrode tab to divide the weld branch;
forming a first side weld body comprising the open trench located adjacent to a second peripheral portion of an intermediate electrode tab located below the upper electrode tab from among the electrode tabs, and a weld branch from among the plurality of weld branches that is located at a first peripheral portion and a central portion of the intermediate electrode tab; and
forming a second side weld body comprising the open trench located adjacent to a first peripheral portion of a lower electrode tab located below the intermediate electrode tab from among the electrode tabs, and a weld branch from among the plurality of weld branches that is located at a second peripheral portion and a central portion of the lower electrode tab.

19. The method claimed in claim 18, wherein the weld terminals are formed by repeatedly arranging a stacking unit comprising the split weld body, the first side weld body, and the second side weld body along the first direction.

20. The method claimed in claim 16, wherein the forming of the lead assembly comprises:
loading the electrode assembly and the electrode lead on an anvil of an ultrasonic welding device, and superimposing the electrode tabs and the electrode lead on the anvil;
pressing the electrode lead using a horn to press a weld portion using the anvil, the weld portion defining a superimposing area between the electrode lead and the electrode tabs; and
applying ultrasonic waves onto the weld portion through the horn to weld the electrode tabs and the electrode lead to each other by frictional heat.
